(19) United States
(12) Patent Application Publication
(10) Pub. No.: US 2006/0118089 A1
(43) Pub. Date: Jun. 8, 2006

(54) Controlling apparatus of variable capacity type fuel pump and fuel supply system

(75) Inventors: Kenichiro Tokuo, Hitachinaka (JP); Satoshi Usui, Hitachinaka (JP); Hiroyuki Yamada, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/217,444

(22) Filed: Sep. 2, 2005

(30) Foreign Application Priority Data
Dec. 7, 2004 (JP) 2004-353491

(51) Int. Cl. F02M 57/02; F02M 59/36; F02M 37/04

(52) U.S. Cl. 123/458; 123/446; 123/506

(57) ABSTRACT

A controlling apparatus of a variable capacity type fuel pump, for avoiding noises caused due to drive of the fuel pump and noises caused due to drive of injectors from overlapping or duplicating with each other in the timing thereof, wherein signals for driving the pump reduced, or the timing thereof is shifted forward/backward, within a specific timing where the o overlapping can be prospected, or a specific timing where they are determined to overlap or duplicate with each other.

### BACKGROUND OF THE INVENTION

The present invention relates to a controlling apparatus of a high-pressure fuel pump for an internal combustion engine, and in particular, it relates to a controlling method of a high-pressure fuel pump for reducing noises within the internal combustion engine.

Conventionally, a controlling apparatus for a fuel pump is already known, for example, in the following Patent Document 1, which comprises a high-pressure fuel pump, for sucking fuel into a pressurizing chamber by changing the volume thereof upon basis of a relative movement of a cylinder and a plunger due to rotation of a cam, thereby sending the fuel sucked towards a fuel injection valve of an internal combustion engine under pressure, and a spill valve for opening/closing a fuel passage, which is provided between a spill passage for flowing out the fuel from the pressurizing chamber, and the pressuring chamber, whereby controlling a period when the spill valve is opened, so as to regulate or adjust an amount of fuel, which is transferred from the high-pressure fuel pump into the fuel injection valve under pressure. In this apparatus, an amount of fuel, which is transferred under pressure per one (1) cycle or stroke thereof, is decreased or reduced by reducing the number of times of fuel injections of the fuel injection valve per one (1) cycle of the transfer of fuel under pressure, when the internal combustion engine operates under the condition of a low load. With this, it is possible to shift a starting period for closing the spill valve up to the top dead center of the cam, i.e., bringing the cam speed to be small when the spill valve is closed, and thereby reducing a sound, which is generated upon closure of the spill valve. And, it is possible to suppress the operating sound of the spill valve from coming up to be relatively large, during the time of an idling operation when operating sounds of the internal combustion engine itself come down to be small, such as, a combustion sound, etc., for example.

Patent Document 1: Japanese Patent Laying-Open No. 2001-41088 (2001).

Thus, with such the conventional art as was mentioned above, since no consideration is paid upon a correlation between the equipments, which constitute the engine, other than the high-pressure fuel pump, therefore no attention is paid on an aspect that the noises are duplicated or overlapped by the equipments themselves, which constitute the engine, i.e., the noises are increased through a synergistic effect thereof.

The noises generated from the engine include, not only the noises caused by the high-pressure fuel pump, but also the noises caused by the injector (i.e., the fuel injection valve) and/or a moving valve, or due to the combustion, etc., for example. Those noises, although being not so large by itself, but sometimes could be felt to be noisy, in particular, due to the synergistic effect, when they are generated overlapping or duplicating with each other in the timing thereof. For example, the injector and the high-pressure fuel pump sometimes generate the noises (i.e., the operation sounds) accompanying with the drives thereof, respectively, and if they are overlapped with each other, they are sometimes felt to be a noise, in particular, being large for the sense of hearing of a human being.

For the injector, the drive timing of which is closely related to the operation condition of the engine, it is not easy to change the drive timing, arbitrarily. Also, with the high-pressure fuel pump (for example, a fuel pump of a variable capacity type), having the structure of controlling the discharge flow amount by changing the drive timing thereof, it is impossible to keep a common rail pressure at a desired pressure, since the discharge flow amount is changed when the drive timing thereof is altered.

### BRIEF SUMMARY OF THE INVENTION

According to the present invention, an object thereof is to avoid the synchronization between the noise, which is caused due to driving of the high-pressure fuel pump, and the noise, which is caused due to operation of the injector, while keeping the engine under a desired operating condition.

For achieving the object mentioned above, according to the present invention, for the purpose of maintaining a predetermined time-interval between the drive timing of an injector and the drive timing of a variable capacity controlling mechanism, which is provided within a variable capacity type fuel pump, so as to eliminate the duplication or overlapping on the drive timings thereof, control is made on the driving on a side of the variable capacity type fuel pump.

According to the present invention, it is possible to avoid the synchronization of noises (i.e., operating sounds) of the injector and the variable capacity type fuel pump, while keeping the engine under the desired operating condition with maintaining the drive timing of the injector.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 shows an entire structure view of a fuel supply system for an internal combustion engine, according to an embodiment of the present invention;

FIG. 2 shows an operation-timing chart of a fuel pump and an injector, shown in FIG. 1;

FIG. 3 shows the details of the timing chart shown in FIG. 2;

FIG. 4 shows a timing chart for explaining about overlapping of noises;

FIG. 5 shows a flowchart for determination of a timing determination circuit, according to an embodiment of the present invention;

FIG. 6 shows an operation-timing chart of a fuel pump and an injector, according to other embodiment of the present invention;

FIG. 7 shows an example of the fuel supply system, which builds up further other embodiment of the present invention;

FIG. 8 also shows an example of the fuel supply system, which builds up further other embodiment of the present invention; and

FIG. 9 shows an operation-timing chart of a fuel pump and an injector, within the fuel supply system shown in FIG. 8.

### DETAILED DESCRIPTION OF THE INVENTION

According to an embodiment of the present invention, in order to keep a predetermined time-interval between the drive timing of the injector and the drive timing of the variable capacity controlling mechanism, which is provided within the variable capacity type fuel pump, so as to eliminate the duplication or overlapping in the drive timings thereof, control is made on the driving on a side of the variable capacity type fuel pump. By doing this, it is possible to avoid the synchronization of noises (i.e., the operating sounds) of the injector and the variable capacity type fuel pump. However, the variable capacity controlling mechanism is a mechanism for controlling a discharge flow amount from the pressurizing chamber, through regulation or adjustment of the fuel to be turned from a pressurizing chamber of the variable capacity type fuel pump back to a side of a low pressure passage, by controlling the drive timing thereof.

In more details thereof, by reducing the number of times of driving of the variable capacity type fuel pump, the predetermined time-interval is maintained between the drive timing of the injector and the drive timing of the variable capacity type fuel pump. For that purpose, at timing when it is impossible to maintain the predetermined time-interval between the driving timing of the injector, it is preferable to bring the variable capacity type fuel pump to be non-driven. Or, it is preferable to bring the variable capacity type fuel pump to be non-driven, when the drive timing of the variable capacity type fuel pump lies within a possible time-interval, during which it may overlap or duplicate the drive timing of the injector in the timing thereof.

The driving of the variable capacity type fuel pump corresponds to the discharge of fuel to a high-pressure side (i.e., a common rail side), and also to the driving (or, controlling) of the variable capacity control mechanism so that the fuel is discharged into the high-pressure side (i.e., the common rail side).

Also, bringing the variable capacity type fuel pump to be non-driven in the operating condition thereof corresponds to that the discharge of fuel is stopped to be supplied from the variable capacity type fuel pump to the high-pressure side (i.e., the common rail side).

Or alternatively, for maintaining the predetermined time-interval between the drive timing of the injector and the drive timing of the variable capacity type fuel pump, the drive timing of the variable capacity type fuel pump is changed so that the predetermined time-interval can be maintained therein.

Further, upon driving of the variable capacity type fuel pump before and after the timing of non-driven or being changed, it is preferable to make an adjustment upon the drive timing, so that a total flow amount does not change, which is discharged from the variable capacity type fuel pump by one (1) cycle of an engine.

By doing this, it is possible to suppress change of the total flow amount discharging from the variable capacity type fuel pump by one (1) cycle of the engine.

Also, it is preferable to achieve a feedback control upon the flow amount discharging from the variable capacity type fuel pump, so that the fuel pressure within the common rail comes to be nearly constant on a time-average. By doing this, even if the number of times is reduced for driving the variable capacity type fuel pump, while conducting no drive upon the variable capacity type fuel pump, however it is possible to increase the flow amount, automatically, discharging from the variable capacity type fuel pump by one cycle or stroke thereof; therefore, it is possible to ensure or maintain the flow amount discharging from the variable capacity type fuel pump within a predetermined time.

Also, it is preferable to apply such the controlling method into an engine (i.e., an internal combustion engine), in particular, into an idling operation condition thereof. Under such condition of the engine where fuel consumption is less in an amount thereof, such as, when it is under the idling operation, since the reduction of pressure is small within the common rail due to fuel injections, therefore, it is possible to apply the present controlling method herein under the condition that pulsation is less in the pressure f the common rail.

Also, it is preferable to achieve the feedback control upon the flow amount discharging form the variable capacity type fuel pump, so as to bring the fuel pressure within the common rail to be nearly constant on an average of one (1) cycle of the engine, by increasing the flow amount discharging from the variable capacity type fuel pump by one (1) cycle thereof, as well as, reducing the number of times of driving for the variable capacity type fuel pump. By doing this, even through the frequency is reduced on discharging from the variable capacity type fuel pump, however it is possible to maintain the fuel supply in the amount thereof, within one (1) cycle of the engine.

Also, it is preferable to make reducing upon the drives of the variable capacity type fuel pump, at a specific timing thereof. If the timing when the noises overlap or duplication can be determined in advance, it is possible to specify a driving signal to be thinned out, but without provision of an overlap determining means; therefore, a controller can be simplified.

Also, it is preferable that, with provision of a timing determining circuit, for determining drive timing for the injector and the variable capacity type fuel pump, wherein if both timings are within a predetermined time band, it is determined that the noises are overlapped or duplicated with each other, and at that timing the variable capacity type fuel pump is brought into the non-driven condition thereof. By doing this, it is possible to avoid the noises from overlapping or duplication thereof, with certainty.

Also, as a means for brining the variable capacity type fuel pump into the non-driven condition, it is preferable that a controlling apparatus gives no drive signal, or that a drive signal is given thereto, which has such a length that the variable capacity type fuel pump cannot operate fully. Thus, the drive signal is made short in the width (i.e., time), comparing to the response time of the variable capacity type fuel pump, so that the drive signal distinguishes before starting of drive of the variable capacity type fuel pump.

Also, it is preferable to shift the timing of applying the drive signal to the variable capacity type fuel pump, forward and backward periodically. By doing this, though a flow amount discharged from the variable capacity type fuel pump repeats an increase/decrease, periodically, however it is possible to change the drive timing of the variable capacity type fuel pump while maintaining the total amount of discharging flow within the predetermined time; i.e., it is possible to avoid the noises from overlapping or duplicating with each other.

### Embodiment 1

Hereinafter, explanation will be given about an embodiment of the present invention.

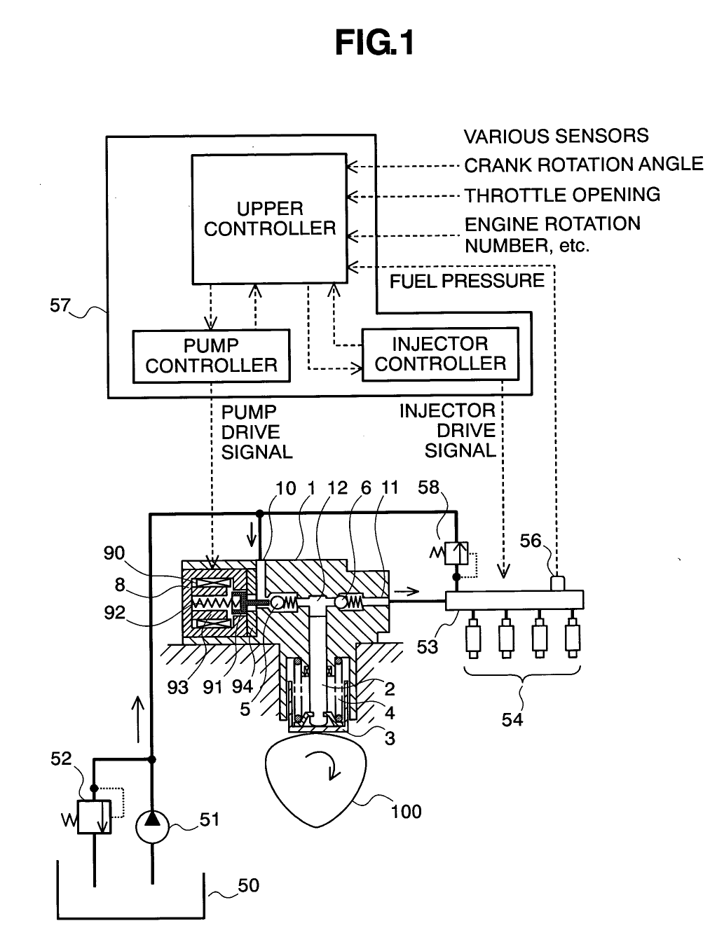

First of all, explanation will be made on the structures of a fuel supply system, which applies the variable capacity type fuel pump according to the present embedment therein, by referring to FIG. 1. In a main body of pump 1 are formed a fuel suction passage 10, a discharge passage 11, a pressurizing chamber 12. Within the pressurizing chamber 12, there is held a plunger 2, slidably, which functions as a pressuring member. In the suction passage 10 and the discharge passage 11 are provided a suction valve 5 and a discharge valve 6, respectively. The suction valve 5 and the discharge valve 6 are held by springs towards one direction, so that they build up a check valve. Also, to the suction passage 10 is connected a low-pressure valve 9.

A variable capacity control mechanism 8 is held within the pump main body 1, and is built up with a solenoid coil 90, a rod 91, and a spring 92. The rod 91 is biased into a direction for opening the suction valve 5, by means of the spring 92, under the condition where no drive signal is applied to the variable capacity control mechanism 8. The biasing force of the spring 92 is determined to be larger than that of the spring for the suction valve 5; therefore, under the condition where no drive signal is applied to the variable capacity control mechanism 8, as is shown in FIG. 1, the suction valve 5 is in the condition of being closed.

Fuel is guided from a tank 50 to the fuel suction passage 10 of the pump main body 1 through a low-pressure pump 51, being adjusted at a constant pressure by means of a pressure regulator 52. Thereafter, the fuel is pressurized within the pump main body 1, to be transferred or supplied from the discharge passage 11 to the common rail 53 under pressure. Onto the common rail 53 are attached injectors 54, a pressure sensor 56 and a safety valve 58. The safety valve 58 closes the valve when the fuel pressure within the common rail 53 goes over a predetermined value, i.e., protecting the high-pressure pipe arrangement system.

The injectors 54 are mounted onto the engine, fitting to the number of cylinders thereof, and each of which injects the fuel in accordance with a signal from a controller 57. The pressure sensor 56 transmits the pressure data obtained to the controller 57.

The controller 57 calculates out an appropriate injection fuel amount and/or a fuel pressure, etc., upon basis of the state quantities of the engine (for example, the crank rotation angle, the throttle opening, the engine rotation number, and the fuel pressure, etc.), which are obtainable from the various sensors, and timing and/or a flow rate for driving the pump 1 and the injectors 54, as well; thereby, transmitting driving signals thereto. The controller 57 may be constructed, sometimes, so that an upper controller for calculating instruction values is separated from a controller for directly transmitting the driving signals to the pump and the injectors, or may be constructed into a unit combining them into one body.

The plunger 2 performs reciprocal movement through a cam 100, which is rotated by an engine camshaft or the like, and thereby changing the volume within the pressurizing chamber 12.

When the suction valve 5 is opened during the discharging process of the plunger 2, pressure within the pressurizing chamber 12 increases, and with this, the discharge valve 6 is opened automatically, so as to transfer the fuel to the common rail 53 under pressure.

The suction valve 5 is opened, automatically, when the pressure within the pressurizing chamber 12 comes to be lower than that of a fuel induction opening. Also, it is automatically opened, when it is released from engagement with the variable capacity control mechanism 8 during the discharging process. The variable capacity control mechanism 8 generates the magnetic field with conducting current through a solenoid 90 when it is provided with the drive signal from the controller 57, and thereby pulling the rod 91, which is biased by the spring 92. By doing this, the suction valve 5 comes out from the engagement with the rod 91; therefore it comes to be an automatic valve, which makes opening/closing thereof in synchronism with the reciprocal movement of the plunger 2. Accordingly, the suction valve 5 is blocked during the discharging process, and the fuel pushes the discharge valve 6 open; the fuel corresponding to reduction of the volume within the pressurizing chamber 12 is transferred to the common rail 53.

On the contrary to this, when no drive signal is provided to the variable capacity control mechanism 8, the rod 91 is in engagement with the suction valve 5 due to the biasing force of the spring 92; i.e., keeping the suction valve 5 in the closed condition thereof. Accordingly, since the pressure within the pressurizing chamber 12 is kept to be nearly equal to that of the fuel induction portion even when the discharging process, then it is impossible to open the discharge valve 6, and the fuel corresponding to the reduction of volume within the pressurizing chamber 12 is turned back to a fuel induction side passing through the suction valve 5. Therefore, it is possible to bring the flow rate discharging from the pump to be zero (0).

Also, when the drive signal is provided to the variable capacity control mechanism 8, on the way of the discharging process, then the rod 91 shifts the position thereof, to be released from the engagement with the suction valve 5, so that it opens the valve;

therefore, the fuel is transferred from the middle on the way of the discharging process to the common rail 53 under pressure. Since the pressure is increased within the pressurizing chamber 12 if starting the transfer of fuel under pressure once, therefore the suction valve 5 keeps the blocking condition thereafter, even when the drive signal is cut off to the variable capacity control mechanism 8, so that the valve is automatically opened in synchronism with starting of the suction process. In this manner, adjusting the timing, when the drive signal is provided to the variable capacity control mechanism 8, enables to regulate or adjust the discharge amount, variably, within a range from zero (0) up to the maximum discharge amount.

Also, with provision of the drive signal to the variable capacity control mechanism 8, through calculation of appropriate discharge timing by means of the controller 57, upon basis of the signal from the pressure sensor 56, it is possible to keep the pressure of the common rail 53 at a nearly constant value.

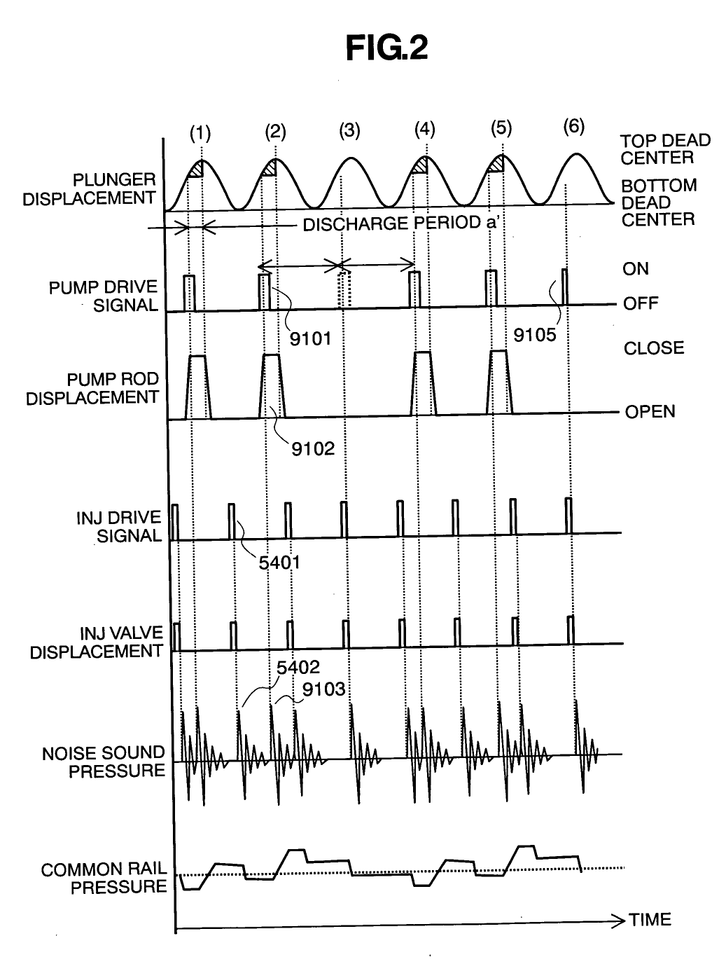

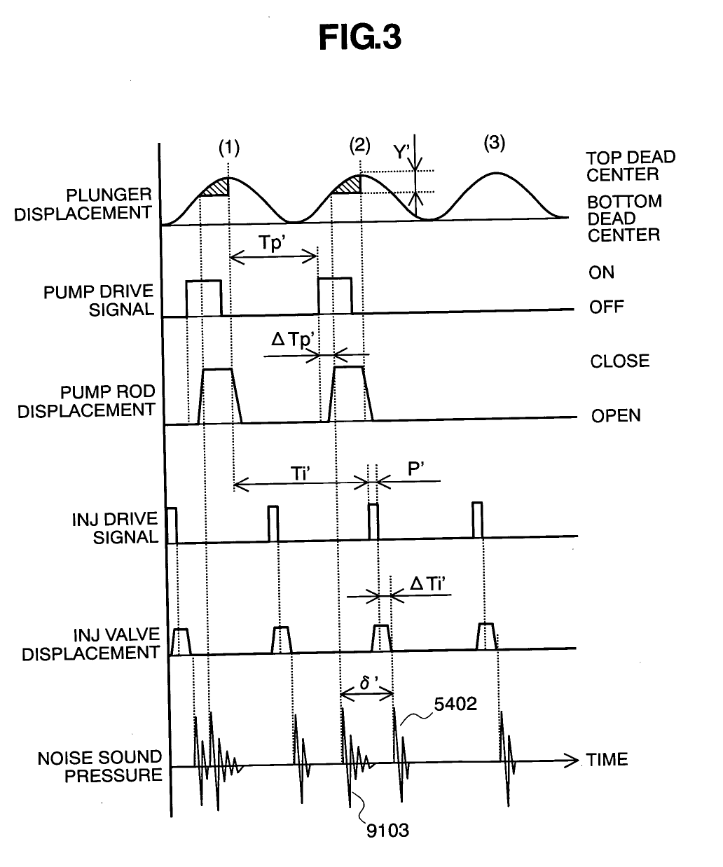

Next, explanation will be given about an example of driving the variable capacity control mechanism 8 of the high-pressure fuel pump, in accordance with the control method of the present invention, by referring to FIGS. 2 and 3.

FIG. 2 shows a drive-timing chart within the fuel supply system mentioned above. “Plunger Displacement” at the uppermost stage indicates the operation of the plunger 2 shown in FIG. 1. A rising process indicates the pressurizing process, while a falling process indicates the suction process. The cam 100, driving the plunger 2 in FIG. 1, has three (3) edges (or projections), and therefore the plunger 2 makes three (3) times of the reciprocal movements per one (1) cycle or stroke of the camshaft 1. In FIG. 2, the plunger makes the reciprocal movements six (6) times; i.e., showing a time range for two (2) revolutions of the camshaft (i.e., for two (2) cycles of the engine). “Pump Drive Signal” is provided at the timing calculated from the controller 57, and the rod 91 shifts the position as is shown by “Pump Rod Displacement”. The rod 91 is engaged with the suction valve 5 under the non-conductive condition thereof, i.e., locating at the position “Open” of keeping the valve opened, while it does no engaged with the suction valve 5 under the conductive condition thereof, i.e., locating at the position “Close” of keeping the valve closed. When the rod 91 shifts the position into the close valve position at certain timing during the pressurizing process, the suction valve 5 is opened, and the pump starts the discharging; therefore, the pressure of the common rail increases. Thus, the fuel is discharged during the time of discharge period a′ shown in the figure. If the timing is early when the pump drive signal is provided, the discharged flow rate is much, on the contrary to that, if it is late, the discharged flow rate is less. The controller 57 controls the timing when the pump drive signal is provided, depending upon the fuel supply amount necessary for the injectors 54.

The injectors 54 are provided, respectively, corresponding to the number of cylinder of the engine, and in the example shown in FIG. 1, there are provided four (4) pieces for a four (4)-cylinder engine. Those are driven one (1) time per one (1) cycle of the engine (=one (1) revolution of the camshaft); i.e., the controller 57 provides the drive signal to the injector, four (4) times in total, per one (1) cycle of the engine. “INJ Drive Signal” shows those injector drive signals. The controller calculates out the timing necessary for the fuel injection and a fuel amount necessary to be injected, and it regulates the timing and the length to be provided to them, respectively; i.e., controlling the injectors 54.

By the way, when the controller 57 turns the pump drive signal ON/OFF, then the rod 91 shifts the position thereof, and it abuts on a stopper 93 or 94 at a terminal end of the stroke thereof; therefore, there is a possibility of generating vibrations and noises therefrom. This sound is the colliding sound, and is a kind of the operating sounds. In the similar manner, with the injectors 54, when the drive signal is turned ON/OFF, there is also a possibility that the vibrations and the noises are generated upon the basis of operations made by the injectors. This noise is the colliding sound generated when the valve body collides on a valve seat and/or a stopper, and it is also a kind of the operating sounds. Those vibration/noise generated when turning the signal ON/OFF are not always same in the magnitude thereof. For example, in relation to the pump, the rod 91 is operated with the electromagnetic force when the signal is ON, while it is operated by the spring 92 when being OFF; therefore, there is a possibility that they are different from each other, in particular, in the magnitude of colliding energy thereof. Also, in relation to the injector, the injection valve is operated to open through the electromagnetic force when the signal is ON, while it is operated to close, by the spring force and the fuel pressure when being OFF; therefore, there is a possibility that that they are different from each other, in particular, in the magnitude of colliding energy thereof. An aspect devised according to the present embodiment lies in that control is made so that the peak value of the pump noises and the peak value of the injector noises will not overlap with each other. For example, in case when the vibrations/noises are large, being caused due to ON operation of the pump and the ON operation of the injector, it is necessary to make such the control that those timings do not overlap with each other. Or, in case when the vibrations/noises are large, being caused due to OFF operation of the pump and the OFF operation of the injector, then it is necessary to make such the control that those timings do not overlap with each other. According to the present embodiment, it is assumed that the vibrations/noises are large, being caused due to ON operation of the pump, and that vibrations/noises are large, being caused due to OFF operation of the injector, and a method will be mentioned, for escaping them from overlaying with each other.

At the second stage from the bottom in FIG. 2, the noise is shown in the form of the sound pressure waveform. For example, when a pump drive signal 9101 is provided, then the rod 91 shifts the position thereof, at the timing shown by rod displacement 9102. When the rod 91 collides on the stopper 93 at the “Close” position, the vibrations/noises (i.e., the colliding sound or operating sound) are generated; i.e., generating a pump drive noise 9103. Although, the vibrations/noises (i.e., the colliding sound or operating sound) are also generated when the pump drive signal is turned OFF, however it is assumed that they are not dominant ones as was mentioned above in the present embodiment; therefore, explanation will be made with paying attention only to the ON operation thereof. In relation to the injector, it is assumed that the noises (i.e., the colliding sound or operating sound), caused when OFF operation, are larger that those when ON operation; therefore, explanation will be made with paying attention onto the OFF operation thereof. When an injector drive signal 5401 is provided, then the valve body of the injector shifts the position thereof, and therefore it generates an injector drive noise 5402. In the figure, the injector drive noise 5402 is generated at the timing after OFF of the injector drive signal.

When the engine operates at a high speed (i.e., when operating at high-load), the plunger 2 of the pump makes the reciprocal movements, at a rate 200 times/second or higher than that. For letting the rod 91 to operate responding to the high speed, fitting to such the reciprocal movements, it is necessary to determine the electro-magnetic force to be sufficiently large, comparing to the biasing force of the spring 92. For that reason, a large colliding force is generated, also when the engine operates at a low speed (i.e., when operating at low-load), such as, an idling operation or the like, the noises (i.e., the colliding sound or operating sound) are heard loud or large for the small engine sound, comparing to that when the engine sound is large. However, when the engine operates at the low speed, such as, under the idling operation, the plunger 2 of the pump makes the reciprocal movements at a degree of about 15 times/second. The cause of the noise generation is similar, in the relationship between the electromagnetic force and the spring biasing force.

With the control method according to the present embodiment, the controller 57 thins or cut out the pump drive signal, one (1) for three (3), periodically. During the plunger cycles (1), (2), (4) and (5), where drive signal is not cut out but is provided, the noises caused due to driving of the pump are generated, but not overlapping with the noises due to driving of the injectors.

On the other hand, during the plunger cycle (3) where the pump drive signal is cut out, of course, no operating sound is generated due to the displacement of the pump rod. For this reason, within this plunger cycle (3), no pump noise overlaps on the injector noise. The position of the drive signal is indicated in the figure by a broken line, if the drive signal is not cut out in that cycle. If the pump is driven at the timing indicated by the broken line, there may be a possibility that the injector noise and the pump noise overlap or duplicate with each other, thereby making the engine noises heard, especially, being loud or large. However, within the plunger cycle (6), the drive signal is narrowed in the width thereof, but in the place of thinning out the drive signal;

thereby inhibiting the rod 91 from being operated. In this regard, explanation will be given later. Thus, in the present embodiment, it is characterized in that the cycle(s) is/are specified, in which the overlap or duplication would occur, in advance, so that the drive signal(s) for it/them is/are deleted. Further, it is also characterized in that the number of times of injections by the pump is reduced, and in addition thereof, the discharge flow rate by one (1) cycle of the pump is increased, thereby maintaining the total flow rate per one (1) cycle of the engine.

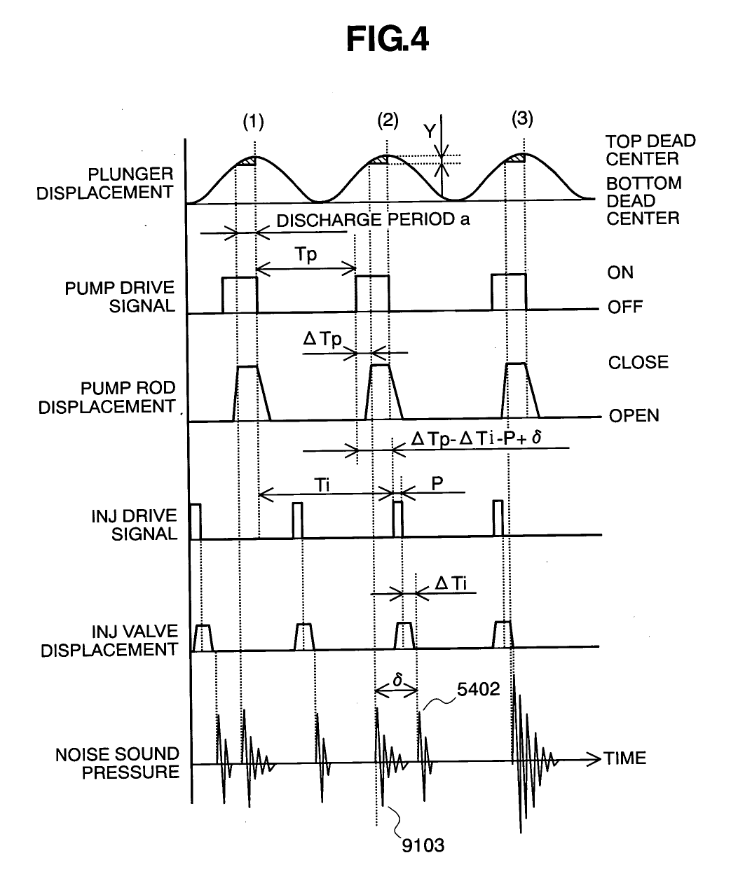

FIG. 3 shows an example of timing chart in case where the pump discharges an amount of fuel, to be discharged by three (3) cycles of, but by two (2) cycles thereof. For the purpose of comparison, FIG. 4 shows the timing chart where the pump discharges the amount by three (3) cycles thereof.

In FIG. 4, the pump drive signal is provided at a certain timing, which is calculated by the controller 57 (in this figure, after the time Tp from the top dead center of the cycle (1), for example). In FIG. 2, though the details thereof were omitted, there is a delay time ΔTp in response within a period after the time when the pump drive signal is provided up to the time when the pump rod shifts the position thereof. After the response delay time ΔTp, the rod 91 shifts the position, so as to close the suction valve 5; therefore, the fuel is discharged, corresponding to the remaining stroke “Y” in the pressurizing process. In this figure, it is indicated that the injector is driven by four (4) times or cycles while the fuel pump is driven by three (3) cycles, and that within the last one (1) cycle (i.e., within the plunger cycle (3)), the noise caused due to the injector driving and the noise caused due to the pump driving are overlapped or duplicated with each other in the timing, thereby increasing the noise level thereof. If changing the pump drive signal within the plunger cycle (3) to the timing before or after thereof, so as to avoid it from the overlapping or duplication, then the flow rate discharged from the fuel pump is increased or decreased; therefore, it is impossible to maintain the pressure within the common rail at a desired value. As a control method for dissolving such the problem, there is a method for supplying the duel discharge equal to that shown in FIG. 4, by two (2) times of discharges thereof.

FIG. 3 shows the timing chart, wherein the method is applied to. In this case, theoretically, the amount discharged by one (1) time or cycle of the pump comes to be 3/2=1.5 times large, comparing to FIG. 4, and the timing of applying the pump dive signal is moved 5 forward. The stroke “Y′”, where the pressurization is made, comes to be 1.5 times large as the stroke “Y” shown in FIG. 3. Actually, by taking the volume efficiency of the pump into the consideration, the relationship is as below, i.e., (Eq. 1):
η′×Y′=η×Y×1.5 (Eq. 1)
where, η′ and η in the equation are the volume efficiencies per a unitary lift amount of the plunger in FIGS. 3 and 4.

Herein, with using a parameter described in FIG. 4, description will be made about the timing of generating the noises. When the drive signal for the pump is give at a certain timing, the pump rod is shifted the position thereof after the delay time ΔTp in response, and it collides on the stopper member 93, thereby generating the vibration/noise. Also, when the drive signal is released, then the pump rod is turned back, and it collides on the stopper 94. Although the vibration/noise is also generated when the drive signal for the pump is turned OFF, however upon the assumption that the collision caused when the pump is turned ON is larger than that caused when it is OFF, as was mentioned previously, in the present embodiment, attentions is paid only onto the vibration/noise, which is generated when the drive signal is turned ON. Thus, on the basis of the top dead center within the plunger cycle (1) shown in FIG. 4, the pump drive signal is turned ON after passing the time Tp from that basis. Assuming as was mentioned above, the timing when the noise is generated due to the pump driving is at the time after passing the time indicated by (Eq. 2) from the basis.
Tp+ΔTp (Eq. 2)

The similar consideration is made about the injectors. In case of the injector, as was mentioned previously, since the vibration/noise caused when the drive signal is OFF is larger, attention is paid onto the vibration/noise when it is OFF. The timing when the vibration/noise is generated due to the OFF operation by the injector drive signal is at the timing when the injection valve shifts the position thereof, after passing the delay time ΔTi, from the time when the injector drive signal is turned OFF. Upon the basis of the top dead center within the plunger cycle (1), if assuming that the time is “Ti” up to when the injector drive signal is turned ON and the length is “P” of the injector drive signal, the timing when the noise is generated due to the injector driving is at the time after passing the time indicated by (Eq. 3) from the basis.
Ti+P+ΔTi (Eq. 3)

Accordingly, time difference “ε” in the timing is as indicated by (Eq. 4), between the noise caused due to the pump and the noise caused due to the injector:
ε=|(Ti+P+ΔTi)−(Tp+ΔTp)| (Eq. 4)

If the time difference “ε” is very small, the noises overlap or duplicate with each other, so that the noises are felt to be large, in particular, for the hearing sense of a human. Within the plunger cycle (3) shown in FIG. 4, the time difference “ε” is very small, and then the sound pressure of noises comes to be large. For the purpose of avoiding this, in the embodiment shown in FIG. 3, such the control is applied that the flow rate is increased to be 1.5 times large within the plunger cycles (1) and (2) while giving no pump drive signal within the plunger cycle (3). By doing this, it is possible to avoid the noises from overlapping with each other, as can be seen in FIG. 4.

Determination can be made on the overlapping or duplication of noises, by deforming the (Eq. 4), in case when:
|(Ti+P+ΔTi)−(Tp+ΔTp)|≦ε (Eq. 5)

The very small time “ε” is a time within from zero (0) to 0.1 ms, approximately, but it should not be limited only to that. Also, this may be obtained by the following (Eq. 5), for example:
ε=n/f (Eq. 6)
where frequency of the sound pressure is “f” and the number of times of vibrations is “n”, being necessary for attenuation of the sound pressure.

For example, if assuming that the frequency of the sound pressure is 30 kHz, and the number of times of vibrations is three (3), up to the time when the sound pressure is almost attenuated; then ε=0.1 ms.

Since the drive signals for the pump and the injector are already given, then ΔTp and ΔTi can be estimated in advance, to be a time up to the time when the noise is generated.

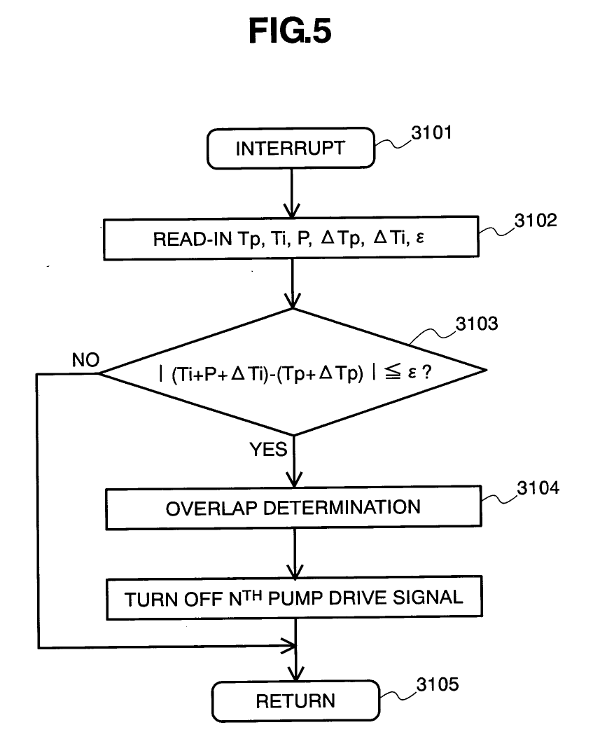

FIG. 5 is a flowchart of a timing determination process, for the controller 57 to determine the overlapping or duplication of noises. In a step 3101, an interruption process is made in synchronism with a time, such as, every 10 ms, for example. However, the said interruption process may be made in synchronism with rotation of the crank angle, such as, every 180° thereof, for example. In a step 3102, the controller reads therein the timing “Tp” when the pump drive signal is provided from a reference position, the timing “Ti” when the injector drive signal is provided from the reference position, the length “P” of the injector drive signal, the response delay time “ΔTp” of pump noise, the response delay time “ΔTi” of injector noise, and the time difference “ε” in timing between those noises generations. The timing “Ti” when the injector drive signal is provided and the length “P” of the injector drive signal are calculated to be appropriate in the values, depending on the operation condition of the engine and an instruction given from a driver (i.e., an acceleration opening, etc.). Also, the timing “Tp” when the pump drive signal is given is determined depending on a flow rate required for the pump. The instruction values Tp, Ti, and P are determined through a predetermined calculation and/or by referring to a map, with obtaining the parameters, such as, the engine rotation speed, the acceleration opening, a drive voltage, the common rail pressure, and a vehicle velocity, etc. Also, the delay times “ΔTp” and “ΔTi” and/or the time difference “ε” can be determined to be values obtainable by referring to a map, in the similar manner. The delay times “ΔTp” and/or “ΔTi” can be measured in advance, and therefore it/they can be given in the form of a fixed value, or a value obtainable by referring to a map.

Next, in a step 3103, a distance between the noises (|(Ti+P+ΔTi)−(Tp+ΔTp)|) is compared with the very small time “ε”, to be smaller than that or not. In case when an answer is “YES”, it is determined that the noises overlap or duplicate with each other, but when it is NO, it is determined that they do not overlap. In case where the pump is driven by plural numbers of times up to the next interruption timing, Tp and Ti may be obtained and/or calculated, in relation to the drive signals of the pump and the injectors, for the plural numbers of times thereof. If determination is made on the overlapping or duplication in the flowchart mentioned above, then the drive signal is not given or provided at that timing. By doing this, it is possible to avoid the overlapping or duplication of noises, with certainty; thereby reducing the noises of the engine.

The control method, being disclosed according to the present invention, is effective when the engine operates under a low load, and further when the engine operates at a low rotation speed, in particular, in the vicinity of the idling rotation speed. In general, the engine noises have a tendency of being small under the condition where the engine rotation speed is low. With avoiding the noises of the pump and the injectors from overlaying or duplicating with each other, even in such the condition, it is further possible to reduce the noises much more. As an effect obtainable by applying the present invention onto the engine when it operates under the low load and the low speed, it is possible to reduce the noises when the engine operates at low rotation speed while maintaining a high output when it operates at high rotation speed.

A gist of the present invention lies in reduction of the noises on the hearing sense, while avoiding the noises, which are generated accompanying with driving of the pump and the injectors, from overlapping or duplicating with each other. As a means for achieving that, according to the present embodiment, there was discloses the example, of stopping or pausing the plunger within the specific one (1) cycle among the three (3) cycle of the plunger cycles; however the overlapping or duplication of noises may be also avoided, by spotting or pausing thereof during the specific two (2) cycles. Or, in case where the pump can discharge the fuel, two (2) times per one (1) cycle of the engine at the maximum, then it may be paused one (1) time thereof.

Also, as is shown by the reference numeral 9105 in FIG. 2, as a means fro stopping or pausing the pump, there is also a method of giving or providing the drive signal, but short, i.e., not sufficient for driving thereof.

Also, within a fuel supply system, in which the controller 57 makes the feedback control of a value of the pressure sensor 56, since compensation can be made, automatically, upon the lowering in the flow rate, with respect to stoppage or pause of the pump, the present invention can be applied therein, easily.

### Embodiment 2

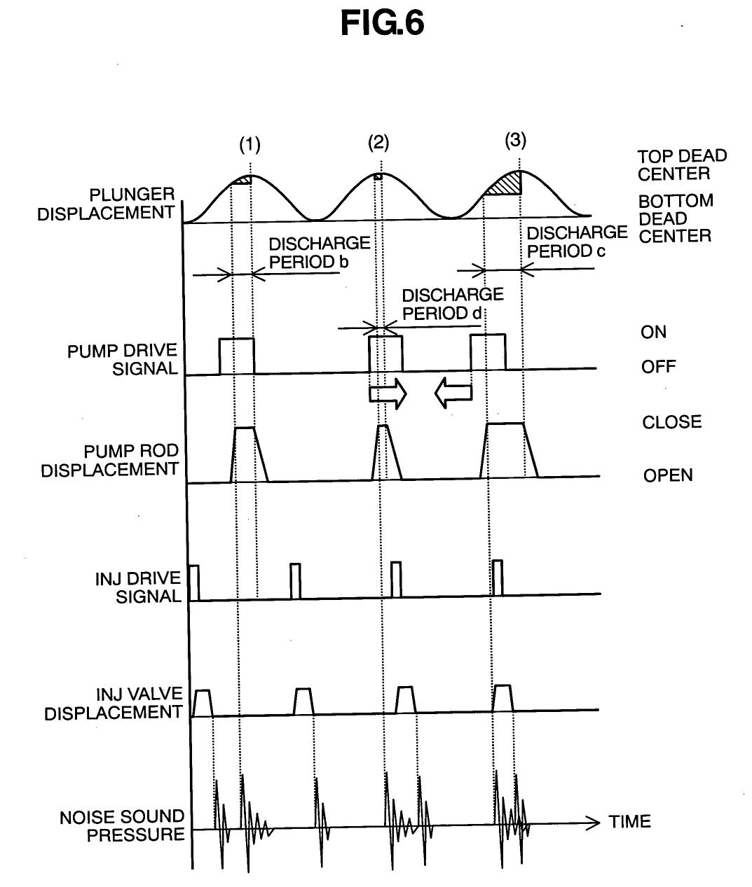

FIG. 6 shows a timing chart, according to other embodiment of the present invention. The structures of the fuel supply system are similar to those of the system shown in FIG. 1.

For avoiding the noises of the pump and the injectors from overlapping on each other within the plunger cycle (3), the timing is moved forward when supplying the pump drive signal. With the pump building up the present invention, the flow rate is increased, being discharged from, when the drive timing thereof is moved forward. Accordingly, if only forward moving is made on the timing when the pump drive signal is provided, for avoiding the overlapping of the noises, then the pump discharges the fuel much more than that of the desired discharge flow rate, thereby bringing about an increase of the fuel pressure within the common rail 53.

However, if reducing the flow rate discharged by shifting the timing of providing the pump drive signal backward, within the plunger cycles (1) or (2), so as to cancel the fuel discharged too much within the plunger cycle (3), then it is possible to discharge the desired amount of fuel, as the total fuel supply amount for one (1) cycle of the engine. Within one (1) cycle of the engine, there are fluctuations in the amount of fuel discharged by the pump, however since the common rail 53 accumulates the fuel pressure therein; therefore, the injectors 54 can inject the fuel under the condition of releasing from or reducing the fluctuation in pressure thereof.

In this manner, through shifting the timing of providing the pump drive signal within one (1) engine cycle, it is possible to avoid the noises from overlapping or duplicating with each other, and further it is possible to control the total amount of fuel supply within the engine cycle at the desired value thereof. In this control mode, there can be observed a phenomenon, such as, the drive signals for the pump come to be unequal in the distance between them, or there is a large difference in magnitude of an increase of pressure, per one (1) cycle of the transferring of the fuel under pressure by means of the pump, etc/

### Embodiment 3

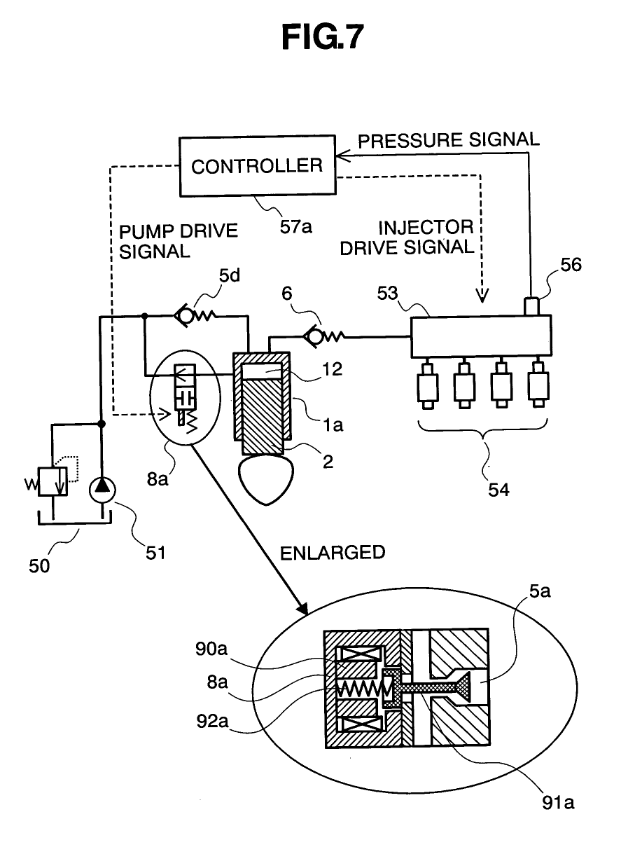

FIG. 7 shows a view of other embodiment.

A fuel pump la repeats the suction/discharge of fuel by conducting the reciprocal movement of a plunger 2a, and also control a flow-amount control mechanism 8a; thereby controlling an amount of fuel to be discharged into a high-pressure side. The flow-amount control mechanism 8a is built up with a suction valve 5a and a rod 91a, being formed in one body, and is biased into a direction to open the valve by means of a spring 92a. When no drive signal is provided to the flow-amount control mechanism 8a, the suction valve 5a is held closing the valve, through the biasing force of the spring 92a; therefore, the fuel pump 1a does not pressurize the fuel therein. When the drive signal is provided from the controller 57a, the suction valve 5a is biased towards the closing position of valve through magnetic sucking force, then it pressurizes the fuel within a pump chamber 12a.

The system of such the structures is similar to the above-mentioned system shown in FIGS. 1 and 2, in the control method thereof; in particular, a flow rate discharged from the pump can be changed by shifting the timing of providing the pump drive signal during the process of pressurizing of fuel. Accordingly, it is possible to apply such the control method therein, as was shown in the embodiment mentioned above.

As a detailed embodiment thereof, description will be give on an example of applying the control method shown as the embodiment 1, by referring to FIG. 3.

“Plunger Displacement” in FIG. 3 shows the change of position of the plunger 2a. “Drive Signal of Pump” is a drive signal, which is provided from the controller 57a to the flow-amount control mechanism 8a, and “Displacement of Pump Rod” indicates the position changes of the rod 91a and the suction valve 5a. Herein, the suction valve 5a is held at the valve opening position through the biasing force of the spring 92a when no drive signal is provided thereto, while it is biased to the valve closing position through the magnetism generated by a solenoid 90a, when the drive signal is provided thereto.

“INJ (Injector) Drive Signals” are the drive signals to be given to injectors 54a, in the similar manner to that of the embodiment mentioned above, and “INJ Valve Displacement” is change in the position of that valve. “Pump Drive Signal” is given at the timing, which is calculated by the controller 57a, and the rod 91a and the suction valve 5a are changed in positions thereof, as shown by “Pump Rod Displacement”. The suction valve 5a is biased and held at the valve opening position by means of the spring 92a under the non-conductive condition thereof, while it is held at the valve closing position through the magnetism generated by the solenoid coil 90a under the conductive condition thereof.

When the suction valve 5a is closed at certain timing during the process of pressuring, the pump stars discharging, and then the pressure increase within the common rail 53a. The flow rate discharged from the pump can be controlled; i.e., to be much when the timing of providing the pump drive signal is early, or to be less when it is late. The controller 57a controls the timing of providing the pump drive signal, depending upon the fuel supply amount that the injectors 54a need.

By the way, when the controller 57a turns the pump drive signal ON/OFF, the rod 91a and the suction valve 5a change the positions thereof, and each of them collides on the stopper 93 or 94 at a terminal end of the stroke thereof; therefore there is a possibility of generating the vibration and/or noise. In the similar manner, with the injectors 54a, as was mentioned previously, there is also a case where the vibration and/or noise is/are generated upon the basis of operation of the injector when turning the drive signal thereof ON/OFF. The magnitude of the vibration/noise is not always the same when turning the signal ON/OFF. For example, since the rod 91a is operated through the electric-magnetic force when being ON while it is operated by means of the spring 92a when being OFF, therefore there is a possibility that the collision energy differs in the magnitude thereof, respectively.

Also, with the injector, since the injection valve is operated to be oven through the electromagnetic force when being ON, while it is operated to close with an aid of the spring force, as well as, the fuel pressure, when being OFF, therefore there is also a possibility that the collision energy differs in the magnitude thereof, respectively. An aspect to be paid attention, herein, is to achieve the control, so that overlapping or duplicating will not made on the energies having large vibration/noise level, in the timing thereof.

For example, in case where the vibrations/noises are large, caused due to ON operation of the pump and due to ON operation of the injector, it is necessary to control those in the timing thereof, so that they do not overlap or duplicate with each other. Or, in case where the vibrations/noises are large, caused due to OFF operation of the pump and due to OFF operation of the injector, it is also necessary to control those in the timing thereof, so that they do not overlap or duplicate with each other.

Also in the present embodiment, it is assumed that the vibration/noise caused due to ON operation of the pump and the vibration/noise caused due to OFF operation of the injector are large, description will be made on the method for avoiding those from overlapping with each other.

In the control method according to the present embodiment, the controller 57a thins the pump drive signals, i.e., cutting out one (1) from three (3) pieces or times of generations thereof, periodically. Within the plunger cycles (1) and (2) where the pump is driven without conducting the thinning of the drive signals, the noises caused due to the driving of pump is generated, but not overlapping or duplicating with the noises caused due to the driving of injectors. On the other hand, during the plunger cycle (3) where the pump drive signal is thinned or cut out, of course, no operating sound is generated due to the change of position of the pump rod. For this reason, within the plunger cycle (3), the pump noise never overlaps with the injector noise.

In the present embodiment, it is characterized in that the cycle(s) is/are specified, within which the overlapping or duplication could be seen to occur, in advance, and then the drive signal is omitted therein. Further, it is also characterized in that the number of times of injections by the pump is reduced, and in addition thereof, the discharge flow rate by one (1) cycle of the pump is increased, thereby maintaining the total flow rate per one (1) cycle of the engine.

### Embodiment 4

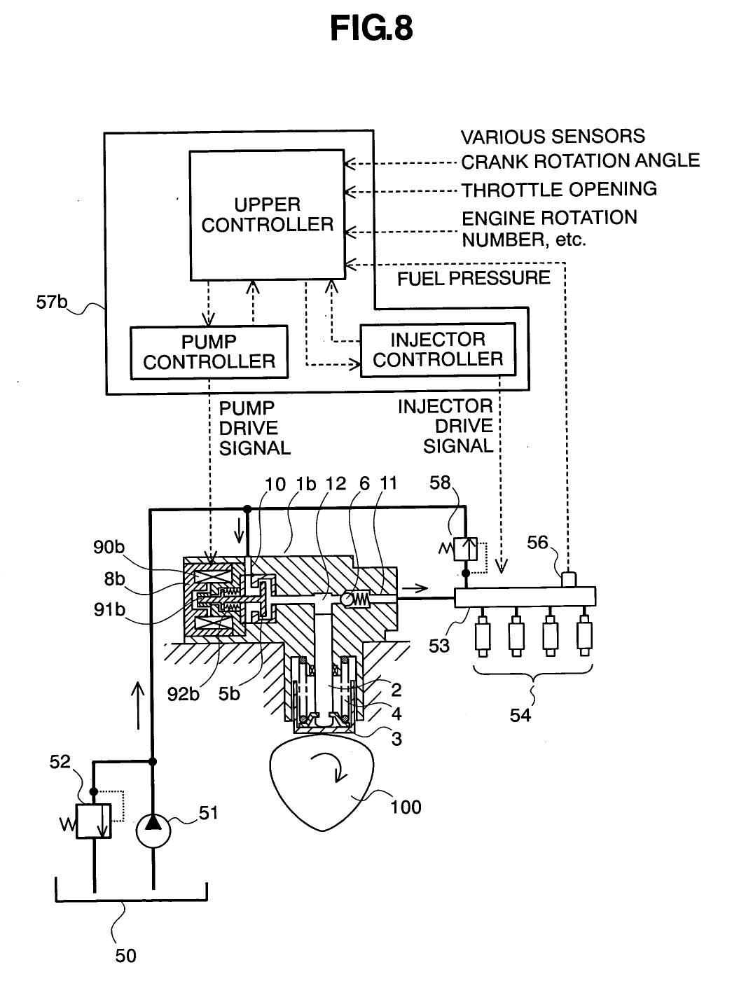

FIG. 8 shows a view of further other embodiment.

A flow-rate control mechanism 8b is built up with a suction valve 5b and a rod 91b, to be in one body, and has such the structure that a spring 92b biases the suction valve 5b into a direction of closing thereof. Also, it has the structure, so that the rod 91b and the suction valve 5b are biased into the direction of opening thereof through magnetic sucking force, when conducting current through a solenoid coil 90b. In the flow-rate control mechanism 9b of such the structure, in case when the controller 57b gives no drive signal to the pump during the process of pressurizing of fuel, the suction valve 5b is kept to close with an aid of the biasing force of the spring 92b; therefore, the fuel pump 1b can pressurize the fuel therein. Also, when the controller 57b keeps providing the drive signal to the pump during the process of pressurizing, the suction valve 5b is biased into the opening position thereof through the magnetic sucking force; therefore, the fuel pump 1b cannot pressurize the fuel therein. Within the fuel supply system comprising the flow-rate control mechanism 8b of such the structures therein, the flow rate discharged therefrom is controlled by chaining the timing of cutting off the drive signal for the pump.

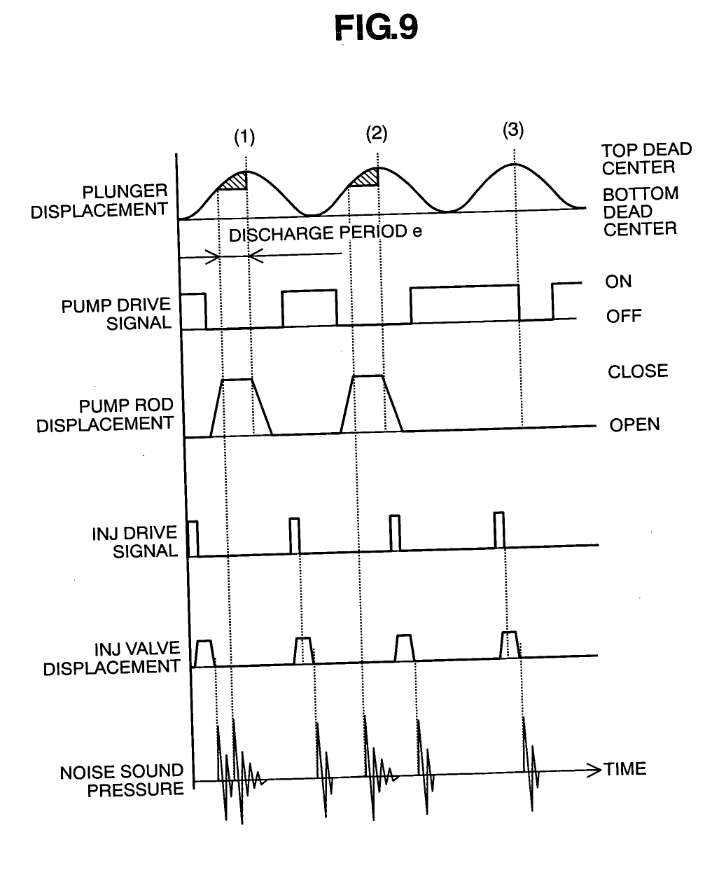

FIG. 9 shows the timing charts of drive signals within the system of such the structures.

In the direction, into which the rod 91b shift the position thereof, it is indicated by “Close” when the pump drive signal is turned OFF, while it is “Open” when the pump drive signal is turned ON. The suctionvalve 5b is opened during the suction process, and the rod 91b and the suction valve 5b are kept at the closing positions thereof through the electromagnetic force, with provision of the pump drive signal given by the controller during that suction process. When the pump drive signal is released at the timing, which the controller 57b calculates out, the rod 91b and the suction valve 5b shift into the closing positions thereof; therefore, the fuel is pressurized within the pump chamber 12b, so as to start the transfer thereof under pressure. In this manner, by changing the timing of cutting off the pump drive signal during the pressurizing process, control is made upon the flow rate discharged from the pump. Noises are generated at the timing when the rod 91b and the suction valve 5b shift the positions thereof, after the ON/OFF operations thereof by the drive signals.

In the present embodiment, explanation will be made hereinafter, upon assumption that the noise generated when the drive signal is turned OFF is larger than that when it is ON.

Within the graph shown in the lowest stage thereof, there is shown main noises caused due to operations of the pump/injectors in the form of waveforms of the sound pressure thereof. The controller 57b thins or cut out the pump drive signals, i.e., one (1) time for-three (3) times thereof, periodically. In more details thereof, during the period up to when completing the pressurizing process within the plunger cycle (3), the drive signals are kept to given, thereby keeping the pump rod into the closing position thereof. With dosing this, the rod 91b does not shift the position thereof within the plunger cycle (3), nor generated the noise due to droving of the pump; therefore, it is possible to avoid the injector noise and the pump noise from overlapping or duplicating with each other. On the other hand, since no fuel is injected during the plunger cycle (3), then the flow rate to be discharged is increased, through bringing the OFF timing to be earlier within the other plunger cycles (1) and (2). By doing so, the fuel comp is able to supply the fuel balancing to an amount of fuel injection by the injectors, and therefore it is possible to obtain the control of maintaining the pressure within a common rail 53b to be nearly constant, on the time-average thereof.

As the condition for applying the control method according to the present invention therein, there may be provided a parameter, such as, the engine rotation speed of the engine load, for example. Namely, as a condition for exercising the present control method, it is detected that the engine operates under the condition of being less than a specific rotation speed, or of the engine load. For example, if reducing the operation numbers of the variable capacity fuel pump (i.e., the number of times of discharging), an amount of discharge is lowered down. Even if trying to compensate the lowering down of the fuel by increasing the discharge amount before and after thereof, however since the fuel amount is much to be consumed within a region or wherein the engine rotation is high, therefore sometimes the compensation may not be sufficient enough thereof. Then, it is preferable to execute the control so as to reduce the number of times of operating the variable capacity fuel pump (i.e., the number of times of discharging) within the idling operation thereof, while do not execute this within a region where the engine rotation speed is higher than that of the idling operation.

Also, at the timing when exchanging between a normal control mode and the control method of the present invention, it is further preferable to increase/decrease the instruction value on the flow rate of the pump, since it can stabilize the pressure within the common rail before and after the timing of exchange between them.

As can be fully understood from the explanation made in the above, the control apparatus for the fuel supply system is able to reduce the engine noises in the hearing sense thereof, avoiding the noises caused due to driving of the injectors and the noises caused due to driving of the pump from overlapping or duplicating with each other, by thinning the drive signals for the pump or shifting them in the timing thereof. Further, for the pump it is able to supply the necessary fuel to the injectors; thereby enabling to maintain the internal combustion engine at a desired operating condition thereof.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. A controlling apparatus of a variable capacity type fuel pump, for transferring fuel under pressure, being pressurized within a pressurizing chamber by a reciprocally movement of a plunger through rotation of a cam, into a common rail for assimilating pressure of the fuel therein, and for controlling timing for driving a variable capacity control mechanism for adjusting the fuel to be returned from said pressurizing chamber back to a side of a low-pressure passage, thereby controlling a flow rate discharged therefrom, wherein
said controlling apparatus controls driving on a side of said variable capacity type fuel pump, so that timing for driving said injector and timing for driving said variable capacity control mechanism have a time interval longer than a predetermined time interval.

2. The controlling apparatus of a variable capacity type fuel pump, as described in the claim 1, wherein said predetermined time interval is such a time interval that operation sound of said injector and operating sound of said variable capacity control mechanism do not overlap with each other.

3. The controlling apparatus of a variable capacity type fuel pump, as described in the claim 1, wherein such control is executed that driving frequency of said variable capacity control mechanism is reduced through invalidating drive of said variable capacity control mechanism in case when the timing for driving said injector and the timing for driving said variable capacity control mechanism are within the predetermined time interval.

4. The controlling apparatus of a variable capacity type fuel pump, as described in the claim 1, wherein such control is executed that the timing for driving said variable capacity control mechanism is changed periodically.

5. The controlling apparatus of a variable capacity type fuel pump, as described in the claim 1, wherein said controlling apparatus executes a drive control on a side of said variable capacity type fuel pump under an idling operation condition of an engine, while it stops said drive control in a condition where a rotation speed of the engine is higher than that of said idling operation thereof.

6. The controlling apparatus of a variable capacity type fuel pump, as described in the claim 1, wherein said controlling apparatus executes a feedback control on the flow rate discharged from said variable capacity type fuel pump, so that fuel pressure within said common rail comes to be about constant on an average of one (1) cycle of an internal combustion engine, by reducing a number of times of discharge of the fuel from said variable capacity type fuel pump, as well as, increasing the flow rate of discharged therefrom per one (1) stroke thereof.

7. The controlling apparatus of a variable capacity type fuel pump, as described in the claim 1, further comprising a timing determination circuit, whereby executing a control of stopping discharge of the fuel from said variable capacity type fuel pump at that timing when the timing for driving said fuel injection apparatus and the timing for driving said variable capacity type fuel pump are within a predetermined time interval.

8. The controlling apparatus of a variable capacity type fuel pump, as described in the claim 1, wherein said controlling apparatus executes control of repeating increase/decrease of the flow rate of the fuel discharged from said variable capacity type fuel pump, by moving the timing for providing a drive signal to said variable capacity control mechanism forward[backward, periodically.

9. A fuel supply system for an internal combustion engine, comprising:
a variable capacity type fuel pump, having such structure that it changes a flow rate of fuel discharged therefrom, through changing a timing of proving a drive signal thereof;
a common rail for accumulating pressure of fuel, which is transferred under pressure from said variable capacity type fuel pump;
injectors, each for injecting the fuel accumulated within said common rail under pressure; and
a controlling apparatus for providing drive signals for said variable capacity type fuel pump and said injectors, wherein
said controlling apparatus controls driving on a side of said variable capacity type fuel pump, so that timing for driving said injector and timing for driving said variable capacity control mechanism have a time interval longer than a predetermined time interval.
